(19) United States
(12) Patent Application Publication
(10) Pub. No.: US 2017/0057781 A1
(43) Pub. Date: Mar. 2, 2017

(54) SYSTEM AND METHOD OF INITIATING ELEVATOR SERVICE USING A COMMUNICATION BRIDGE

(71) Applicant: OTIS ELEVATOR COMPANY, Farmington, CT (US)

(72) Inventor: Peter DePaola, South Windsor, CT (US)

(21) Appl. No.: 15/250,483

(22) Filed: Aug. 29, 2016

Related U.S. Application Data
(60) Provisional application No. 62/211,176, filed on Aug. 28, 2015.

(51) Int. Cl. B66B 1/34; B66B 1/46; B66B 3/00

(52) U.S. Cl. CPC B66B 1/3461; B66B 3/002; B66B 1/468; B66B 2201/4607; B66B 2201/4653; G08C 17/02

(57) ABSTRACT

A system and method of initiating service of an elevator system including an elevator control system in communication with at least one elevator fixture including a communication bridge, communication switch, the elevator fixture in further communication with a plurality of communication modules. The method includes operating a mobile device to receive a travel request, operating the mobile device to wirelessly transmit to the communication module a travel signal based on the travel request, operating the plurality of communication modules to wirelessly receive the travel signal and to wirelessly transmit the travel signal to the elevator fixture, operating the elevator fixture to wirelessly receive the travel signal and to transmit the travel signal to the elevator control system, and operating the elevator fixture to receive dispatch information from the elevator control system and wirelessly transmit the dispatch information to the plurality of communication modules.

### CROSS-REFERENCE TO RELATED APPLICATIONS

The present application is a nonprovisional patent application, which claims priority to U.S. Provisional Patent Application Ser. No. 62/211,176, filed Aug. 28, 2015, and having the title “SYSTEM AND METHOD OF INITIATING ELEVATOR SERVICE USING A COMMUNICATION BRIDGE,” which is herein incorporated in its entirety.

### TECHNICAL FIELD OF THE DISCLOSED EMBODIMENTS

The presently disclosed embodiments generally relate to elevator systems and more specifically, a system and method of initiating elevator service using a communication bridge.

### BACKGROUND OF THE DISCLOSED EMBODIMENTS

Modern elevator systems are essential in multi-story buildings. Ideal use of an elevator system requires efficient and convenient means of requesting and dispatching elevator service. Generally, a passenger seeking elevator service must first initiate service via an elevator fixture located in the hallway immediately near an elevator (or a bank of elevators). Once the elevator car arrives the passenger boards and then selects a destination floor from a number of buttons on a car fixture.

Once the request for service is made, the passenger may have to wait up to several minutes for the car to arrive, and in certain situations, access to the car buttons may be obstructed. There is therefore a need for a more convenient and faster method of initiating an elevator call and selecting a desired destination floor.

### SUMMARY OF THE DISCLOSED EMBODIMENTS

In one aspect, an elevator system is provided. The elevator system includes at least one elevator fixture operably coupled to an elevator control system. In one embodiment, the at least one elevator fixture includes a communication bridge operably coupled to a communication switch. The elevator control system is configured to coordinate all aspects of elevator service such as travel, speed, and accelerating, decelerating, door opening speed and delay, leveling and hall fixture signals.

The communication bridge is in further communication with a plurality of communication modules disposed throughout a building. Each of the plurality of communication modules is configured to allow a passenger to wirelessly communicate to the at least one elevator fixture.

In one aspect, a method of initiating elevator service is provided. The method includes the steps of: operating a mobile device to receive a travel request, operating the mobile device to transmit a travel signal to at least one of the plurality of communication modules based on the travel request, wherein the travel signal is indicative of at least one of a direction of travel and a destination floor, operating the at least one of the plurality of communication modules to wirelessly receive the travel signal and wirelessly transmit the travel signal to the at least one elevator fixture, operating the at least one elevator fixture to wirelessly receive the travel signal and transmit the travel signal to the elevator controller, operating the at least one elevator fixture to receive dispatch information from the elevator control system, and wirelessly transmit the dispatch information to the mobile device. In an embodiment, the method further includes the step of the displaying the dispatch information on the mobile device.

In an embodiment, receiving a travel request includes operating a program stored on the mobile device to select a destination floor. In at least one embodiment, dispatch information includes at least one of confirmation of a dispatched car, car identification, and arrival time.

Other embodiments are also disclosed.

### BRIEF DESCRIPTION OF DRAWINGS

FIG. 1 illustrates a schematic drawing of an elevator system; and

FIG. 2 illustrates a schematic flow diagram of a method for initiating elevator service.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

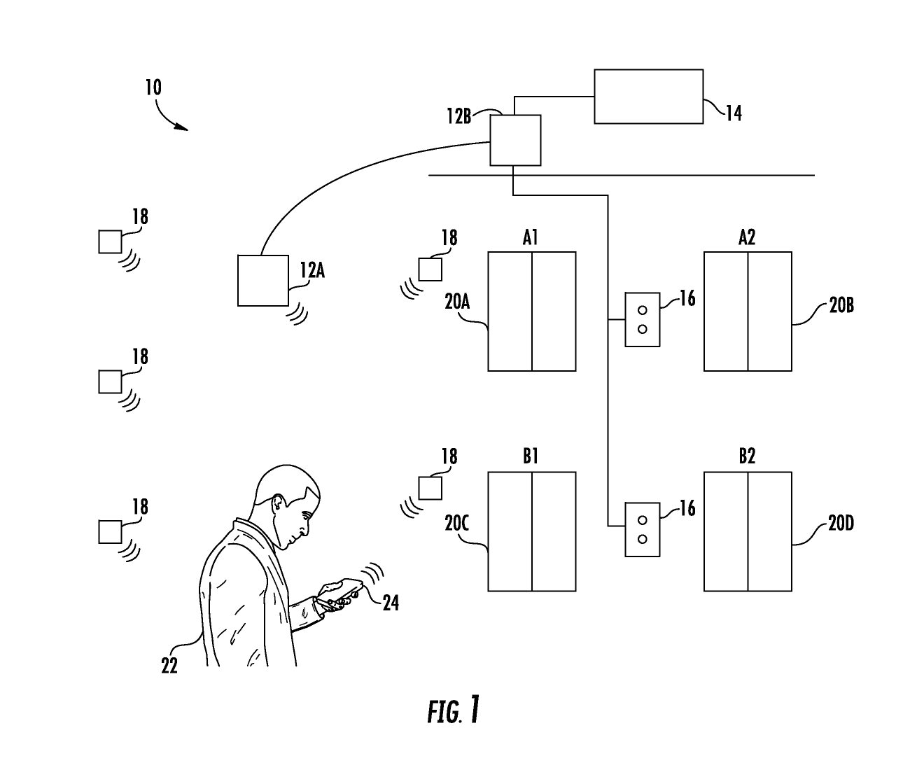

FIG. 1 illustrates selected portions of an elevator system, generally indicated at 10. The elevator system 10 includes at least one elevator fixture 12A, 12B operably coupled to an elevator control system 14. In one embodiment, the at least one elevator fixture 12 includes a communication bridge 12A operably coupled to a communication switch 12B.

In an embodiment, the communication bridge 12A may include such transceivers as a BLUETOOTH LE enabled module to name one non-limiting example. In an embodiment, the communication switch 12B may include such switches as an Ethernet switch to name one non-limiting example. It will be appreciated that the communication switch 12B may be in communication with other fixtures 16, for example elevator kiosks and hall fixtures to name a couple of non-limiting examples. The elevator control system 14 is configured to coordinate all aspects of elevator service such as travel, speed, and accelerating, decelerating, door opening speed and delay, leveling and hall fixture signals.

The communication bridge 12A is in further communication with a plurality of communication modules 18. In an embodiment, each of the plurality of communication modules 18 includes a BLUETOOTH LE transceiver. In an embodiment, the plurality of communication modules 18 are placed throughout a building, for example at or near a bank of elevator cars 20, in a building lobby, building suite, hallways, individual offices, etc. to name a few non-limiting examples. In some embodiments, the plurality of communication modules 18 may also be placed external of the building, for example at any entrance to the building, the parking lot, etc. to name a couple of non-limiting examples. Each of the plurality of communication modules 18 is configured to allow a passenger 22 to wirelessly communicate to the at least one elevator fixture 12.

For example, when a passenger 22 typically wishes to initiate service for an elevator, the passenger 22 approaches the hall fixture 16 and presses an up button to request travel in the up direction, or presses a down button to request travel in the down direction.

The elevator control system 14 dispatches an elevator car 20 to the requested floor. Generally, after the arrival of the elevator car 20, the passenger 22 boards and then selects a button from the car fixture (not shown) indicative of the passenger's destination floor. The elevator car 20 then travels to the requested destination floor, where upon arrival the passenger 22 exits the elevator car 20.

In the present embodiment, the passenger 22 operates an application program stored on a mobile device 24 to request elevator service. The mobile device 24 also includes a mobile device communication device (not shown) that is configured to wirelessly communicate with the plurality of communication modules 18. It will be appreciated that the mobile device 24 may be any mobile device operable to perform the functions disclosed herein, for example, a mobile telephone, tablet device, or any device capable of being carried by a person outside of a home, or other structure, to name a few non-limiting examples.

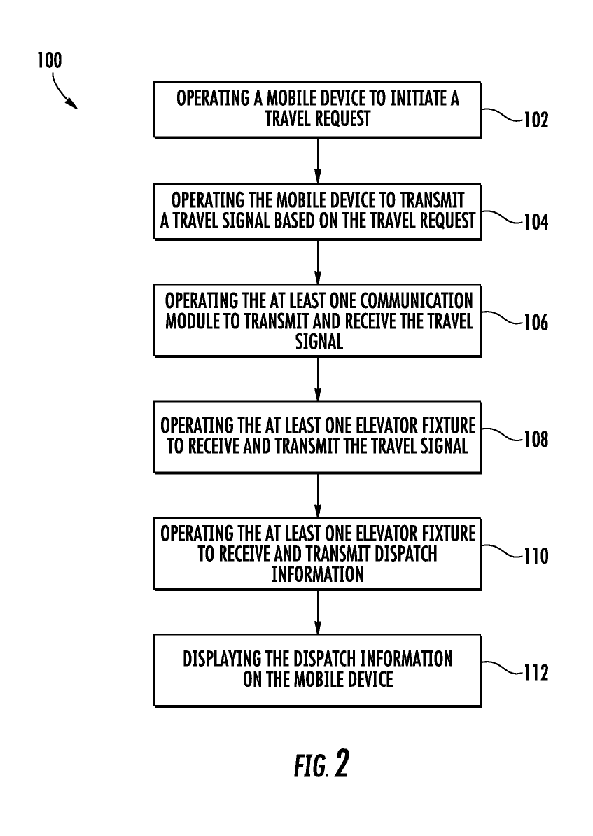

FIG. 2 illustrates a method, generally indicated at 100, of initiating elevator service. The method 100 includes step 102 of operating the mobile device 24 to receive a travel request. In an embodiment, receiving a travel request includes operating a program stored on the mobile device 24 to select a destination floor.

The method 100 further includes step 104 of operating the mobile device 24 to wirelessly transmit a travel signal to at least one of the plurality of communication modules 18 based on the travel request, wherein the travel signal is indicative of at least one of a direction of travel and a destination floor.

The method 100 further includes step 106 of operating the plurality of communication modules 18 to wirelessly receive the travel signal and wirelessly transmit the travel signal to the at least one elevator fixture 12. For example, once any of the communication modules 18 wirelessly receives the travel request, the communication module 18 wirelessly transmits the travel signal to the communication bridge 12A.

The method 100 further includes step 108 of operating the elevator fixture 12 to wirelessly receive the travel signal and wirelessly transmit the travel signal to the elevator controller 14. For example, once the communication bridge 12A wirelessly receives the travel signal, the communication bridge 12A wirelessly transmits the travel signal to the communication switch 12B, which in turn transmits the travel signal to the elevator control system 14. The elevator control system 14 operates to determine the location, direction of current travel, speed, etc. of the elevator cars 20 in order to determine which of the elevator cars 20 could attend to the travel request based on the travel signal.

The method 100 further includes step 110 of operating the elevator fixture 12 to receive dispatch information from the elevator control system 14, and wirelessly transmit the dispatch information to the mobile device 24. In at least one embodiment, dispatch information includes at least one of confirmation of a dispatched car, car identification, and arrival time.

For example, once the elevator control system 14 determines which elevator car 20A, 20B, 20C, 20D can service the travel request, the elevator control system 14 sends dispatch information to the communication switch 12B to the communication bridge 12A. The communication bridge 12A subsequently wirelessly transmits the dispatch information through the plurality of communication modules 18 to the mobile device 24 confirming that a car is being dispatched to the passenger's location; identifying which car 20 (e.g. “B1”) will attend to the request, and the approximate wait time for the car 20 to arrive. As the passenger 22 continues to walk through the building to the elevator cars 20, and/or as the passenger 22 approaches the building, and/or as the passenger 22 waits for the elevator car 20 to arrive, the at least one communication bridge 12A wirelessly transmits the dispatch information to the mobile device 24.

In an embodiment, the method 100 further includes step 112 of the displaying the dispatch information on the mobile device 24. For example, the passenger 22 may operate the mobile device 24 to view the boarding location of the selected elevator car 20 to help the passenger 22 easily navigate to the proper location. It will be appreciated that the dispatch information may be rendered by any means readily recognized and understood by those skilled in the arts, such as, for example, by visual and/or audible signals to alert the passenger 22 as to the proper elevator car 20 attending to the travel request.

An example of the method 100 disclosed herein includes a scenario where the passenger 22 may enter the doors of a building. Either prior to entry or after entry the passenger 22 enters a request to travel from floor 1 to floor 11 on the application stored in the mobile device 24. As the passenger 20 navigates towards the elevator cars 20, the travel signal is transmitted from the mobile device 24 and received by one of the multiple communication modules 18 placed throughout the building. The communication module 18 receives the travel signal and transmits the travel signal to the communication bridge 12A. The communication bridge 12A receives the travel signal and transmits the travel signal to the elevator control system 14 through the communication switch 12B.

Based on which communication module 18 received and transmitted the travel signal, the elevator control system 14 may best determine which elevator car 20 will answer the travel request. Alternatively, the elevator control system 14 may monitor the time of movement of the passenger 22 to best determine which elevator car 20 will answer the travel request.

For example, when the passenger 22 enters the building a first communication module 18 may receive and transmit the travel signal. As the passenger 22 moves towards the elevator cars 20, the passenger 22 may pass other communication modules 18 in route. Each of those modules receives the travel signal and transmits the signal to the elevator control system 14 through the communication bridge 12A and communication switch 12B. The elevator control system 14 may monitor the time between the travel signals to best determine which elevator car 20 will answer the travel request. After the elevator control system 14 has determined which elevator car 20 will answer the travel request, the elevator control system 14 transmits the dispatch information to the mobile device 24 via the communication switch 12B, communication bridge 12A, and the communication modules 18.

It will be appreciated that the elevator system 10 includes a communication bridge 12A in communication with communication modules 18 placed throughout a building to allow a passenger to quickly and seamlessly request elevator service without the need for manually pressing buttons on a traditional fixture.

While the present disclosure has been illustrated and described in detail in the drawings and foregoing description, the same is to be considered as illustrative and not restrictive in character, it being understood that only certain embodiments have been shown and described and that all changes and modifications that come within the spirit of the present disclosure are desired to be protected.

1. An elevator system operable within a building, the elevator system comprising:
an elevator control system configured to receive a travel signal, generate dispatch information based in part on the travel signal, and transmit the dispatch information;
an elevator fixture configured to wirelessly receive the travel signal and wirelessly transmit the dispatch information, the elevator fixture operably coupled to the elevator control system and configured to transmit the travel signal to the elevator control system and receive the dispatch information from the elevator control system; and
a plurality of communication modules disposed in multiple locations throughout the building, each of the plurality of communication modules are configured to wirelessly receive and transmit the travel signal and the dispatch information, the at least one communication module in communication with the elevator fixture.

2. The elevator system of claim 1, further comprising a mobile device configured to wirelessly transmit the travel signal and wirelessly receive the dispatch information, the mobile device in communication with the plurality of communication modules.

3. The elevator system of claim 1, wherein the plurality of communication modules are further located external of the building.

4. The elevator system of claim 1, wherein the elevator fixture comprises a communication bridge operably coupled to a communication switch.

5. The elevator system of claim 1, wherein the travel signal is indicative of at least one of a direction of travel and a destination floor.

6. The elevator system of claim 4, wherein the communication bridge comprises a BLUETOOTH LE transceiver.

7. The elevator system of claim 4, wherein the communication switch comprises an Ethernet switch.

8. The elevator system of claim 1, wherein the communication module comprises a BLUETOOTH LE transceiver.

9. The elevator system of claim 1, wherein the mobile device comprises at least one of a mobile telephone and a tablet device.

10. A method of initiating elevator service for an elevator system including an elevator fixture in communication with an elevator control system and a plurality of communication modules disposed throughout a building, and a mobile device in communication with the plurality of communication modules, the method comprising:
(a) operating the mobile device to receive a travel request;
(b) operating the mobile device to wirelessly transmit to the plurality of communication modules a travel signal based on the travel request;
(c) operating the plurality of communication module to wirelessly receive the travel signal and to wirelessly transmit the travel signal to the elevator fixture;
(d) operating the elevator fixture to wirelessly receive the travel signal and to transmit the travel signal to the elevator control system; and
(e) operating the elevator fixture to receive dispatch information from the elevator control system and wirelessly transmit the dispatch information to the communication module.

11. The method of claim 10, wherein step (a) comprises operating a program stored on the mobile device to select a destination floor.

12. The method of claim 10, wherein the travel signal is indicative of at least one of a direction of travel and a destination floor.

13. The method of claim 10, wherein step (c) further comprises operating the communication module to determine an approximate location of the mobile device based at least in part on the location of the communication module transmitting the travel signal.

14. The method of claim 10, wherein the at least one elevator fixture comprises a communication bridge operably coupled to a communication switch.

15. The method of claim 10, wherein step (e) further comprises:
(i) operating the elevator fixture to transmit the travel signal to the elevator control system;
(ii) operating the elevator control system to determine dispatch information.
